(19) United States
(12) Patent Application Publication
(10) Pub. No.: US 2004/0145331 A1
(43) Pub. Date: Jul. 29, 2004

(54) Method for electronic regulation of an electric motor

(76) Inventors: Daniel Gloaguen, Chatellerault (FR); Abdou Salembere, Chatellerault (FR)

Correspondence Address: Andrew R Basile, Young & Basile, Suite 624, 3001 West Big Beaver Road, Troy, MI, 48084, US

(21) Appl. No.: 10/476,358

(22) PCT Filed: Apr. 25, 2002
(86) PCT No.: PCT/FR02/01447

(30) Foreign Application Priority Data
Apr. 30, 2001 (FR) 01/06145

(51) Int. Cl. H02P 1/04

(52) U.S. Cl. 318/443

(57) ABSTRACT

A method for electronic regulation of an electric motor for driving at least a wiper moving on a glass surface where a control device supplies the motor with voltage by specific pulse durations, each pulse duration determining a substantially rectilinear characteristic curve of operating points corresponding to doublets of values, respectively of the torque and of the angular speed of the motor, between two threshold points corresponding to a null-couple angular speed and to a null-speed torque. The voltage pulse duration is controlled on the basis of the measured value of the intensity of the current powering the motor, so as to obtain each required doublet of values or operating point.

The invention concerns a method for electronic regulation of an electronic motor.

The invention concerns, more specifically, a method for electronic regulation of an electronic motor, in particular of a wiper mechanism motor in order to drive at least a wiper blade or arm, moving on a glass surface, of the type in which a control device supplies the motor with voltage by specific pulse durations, each pulse duration determining a substantially rectilinear characteristic curve of operating points corresponding to doublets of values, respectively of the torque and the angular speed of the motor, between two threshold points corresponding to a null-couple angular speed and a null-speed torque.

The base equations of a direct current motor, integrating all energy phenomenon, are the following.

The internal characteristic of the direct current motor is expressed by the equation:

U=E+R*I (1)

In this equation, U represents the voltage supply of the motor, E its electromotive armature force, R the resistance of its armature, and I the intensity of the current.

The motor speed characteristic is expressed by the equation:

E=Kω (2)

In this equation, K represents the electromagnetic constant, and ω the angular speed of the motor.

The motor torque characteristic is expressed by the equation:

Cm=K*I (3)

In this equation, Cm represents the electromagnetic torque or the motor torque.

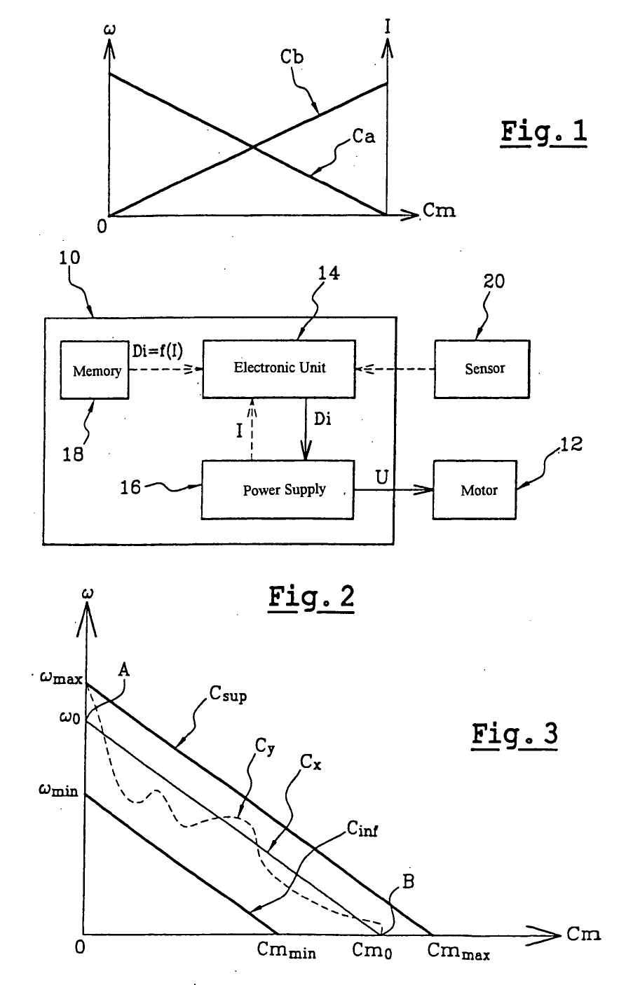

These equations are translated graphically by the characteristic curve Ca of the angular speed ω as a function of the torque Cm and by the characteristic curve C_{b} of the intensity of the current I as a function of the torque Cm, which are represented in FIG. 1.

The characteristic curve Cₐ of the angular speed ω as a function of the torque Cm is linked to a voltage value U.

Generally, in order to respond to the constraints of many applications of a wiper motor for several vehicle types, it is necessary to foresee different armatures, with varying windings, in particular, variances of the wire diameter and number of turns.

For a wiper motor there can be, for example, twenty-five armature references that each correspond to a distinct wiper motor application, such that the performance of the wiper motor is adapted to the distinct vehicle models.

It is also necessary to be able to vary the angular speed ω of the motor during its operation, for example in order to slow down the wiper when it arrives in proximity of the end of its course, in such a way as to reduce the negative inertial effects due to the stored kinetic energy of the wiper during its rotation and/or translation.

In known systems, when one wishes to vary the angular speed ω of the motor, in order to achieve, for example, a lower speed PV or a higher speed GV, one modifies the voltage power supply U to the motor terminal, which provokes in parallel a modification of the available motor torque Cm.

One cannot thus lower the speed ω of the motor without diminishing the available motor torque Cm.

In addition, there is a large dispersion of performances (speed, torque, etc.) in a series of wiper motors issued from the same production line, which can lead to rejection or to reliability problems.

The invention provides remedies to these inconveniences.

The invention also addresses the ability to use a single motor armature for several applications having different speed characteristics, without being penalized in terms of motor torque.

With this goal, the invention proposes a method of electronic regulation of the type described above, characterized in that one controls the voltage pulse duration as a function of the measured value of the intensity of the current powering the motor, in such a way as to obtain each doublet of values, or operating point, required.

According to other characteristics of the invention:

the pulse duration is indexed on the values of the plateau of the intensity of the current;

the number of values of the plateau of the current can be augmented with the spread between the maximum null-couple angular speed and the null-couple angular speed required;

the size of each plateau can be close to zero so that the associated plateau substantially corresponds to a punctual value;

one controls the pulse duration in order to globally follow a theoretical characteristic curve linking the null-couple angular speed to the null-speed torque required;

the theoretical characteristic curve is a line linking the required null-couple angular speed to the required null-speed torque;

one controls the pulse duration in order to globally follow, within the design-defined limits of the physical capacity of the motor, a line that links the null-couple angular speed to a null-speed virtual motor torque, the null-speed virtual motor torque being greater than the maximum null-speed torque as long as the motor torque is lower than that of a design-defined value;

the virtual motor null-speed torque is defined by design;

the null-speed torque required is the maximum null-speed torque of the motor which is design defined;

the values of the pulse duration as a function of the values of the intensity of the current are recorded in a table, the contents of which vary as a function of the operating points required by the motor, and by controlling the pulse duration following the indications of the table;

at regularly spaced intervals, the control device calculates the pulse duration used by the motor, by means of a transfer function, the transfer function varying as a function of the operating points required by the motor;

the operating points required by the motor depend significantly on the position of the wiper blade, or arm, on the glass surface;

the operating points required are determined so as to reduce the stored kinetic energy of the wiper blade, while coming close to the end of wiped surface;

the process is started by a control device comprising a numerical and/or analog electronic control unit.

Other characteristics and advantages of the invention will appear in the reading of the detailed description that follows, for the comprehension of which one will to refer to the attached drawings in which:

FIG. 1 is a diagram that represents the current characteristic as a function of the torque and the speed characteristic as a function of the current of an electric motor;

FIG. 2 is a schematic that represents a control device of an electric motor for starting an electronic regulation process according to the invention;

FIG. 3 is a diagram that represents the characteristic curves of the angular speed of a motor as a function of the motor torque corresponding to the maximum voltage pulse duration and to the minimum voltage pulse duration;

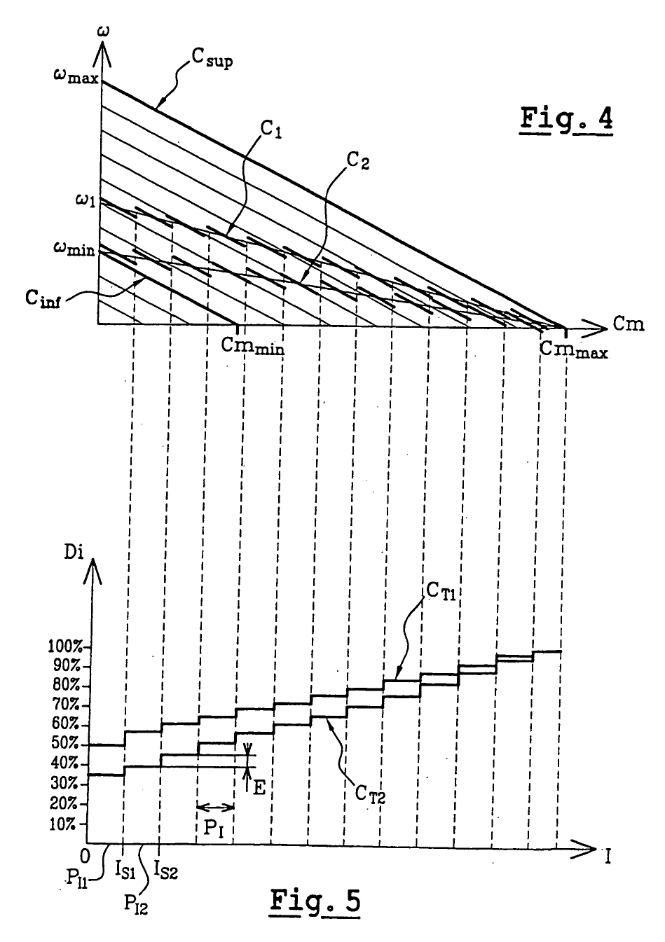

FIG. 4 is a diagram similar to that in FIG. 3 which represents two examples of characteristic curves constructed from two tables associating a pulse duration to each current intensity plateau;

FIG. 5 is a diagram that represents the pulse durations as a function of the direct current plateaus in the two tables used in FIG. 4;

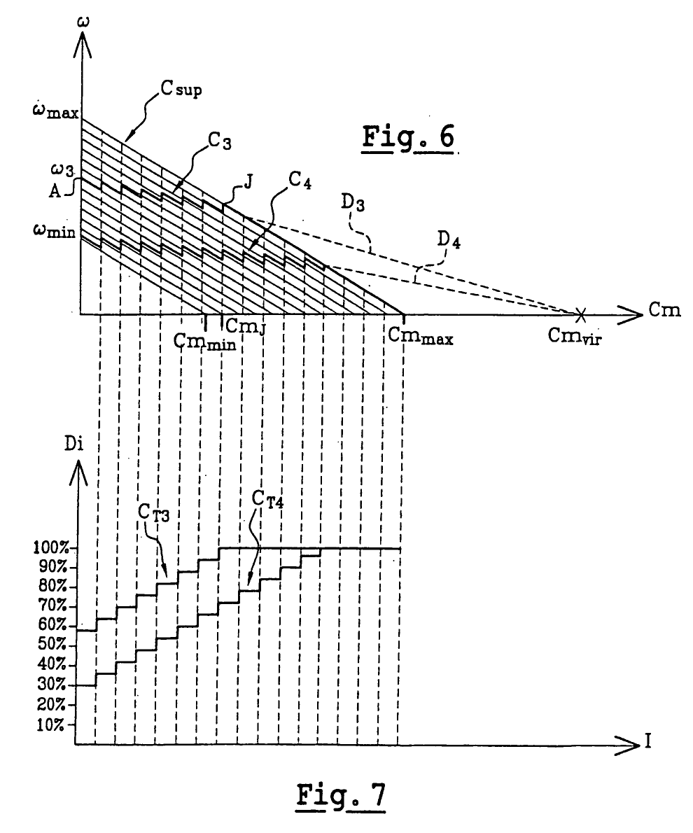

FIG. 6 is a diagram similar to that in FIG. 4 which illustrates a production variance of the invention in which the characteristic curves follow a straight line crossing a null-speed virtual torque value;

FIG. 7 is a diagram similar to FIG. 5 which represents current/voltage tables used for constructing the characteristic curves of FIG. 6.

Represented on FIG. 2 is a control device 10 that will control the electric motor 12 of a wiper mechanism (not represented) according to a method conforming to the specifications of the invention.

The wiper mechanism drives, for example, a wiper blade that moves across a glass surface.

The control device 10 comprises here an electronic control unit 14 that drives the power supply device 16 of the motor 12, and recording means 18.

The power supply device 16 furnishes the motor 12 with voltage power U in the form of pulses of an amplitude of Uₐ the duration Di of which can vary in relation to a given period of time T.

Because of its elevated time constant in relation to the period T, the motor 12 functions as if it is permanently powered by a voltage U_{moy} that corresponds to an average value of the voltage Uₐ during period T, the angular speed ω value of the motor 12 adapts then to this average voltage U_{moy}.

The motor 12 is, for example, defined to function under a voltage Uₐ of 13 Volts.

However, for a given period of time T, the voltage Uₐ pulses can extend, for example, over most of the period T. The average voltage U_{moy} “seen” by the motor 12 is thus 6.5 Volts.

The power supply device 16 can modify the power supply voltage U of the motor 12 via modulation of the pulse duration Di, or “Pulse Width Modulation” (PWM).

In the following description, the pulse duration Di is expressed as a percentage which corresponds to the ratio of the voltage Uₐ pulse duration Di to the duration of period T.

By design, each pulse duration Di determines a power supply voltage U, and thus a substantially rectilinear characteristic curve Cₓ, of operating points corresponding to doublets of values, respectively of the torque Cm and the angular speed ω of the motor 12, between two threshold points A and B corresponding to the null-couple angular speed ω₀, and to the null-speed torque Cm₀ respectively.

An example of such a characteristic curve Cₓ is represented in FIG. 3.

One will note that the null-couple angular speed ω₀ is the angular speed ω of the motor without charge, that is to say, when it doesn't encounter a resisting torque.

One will also note that the characteristic curves Cₓ of the motor 12 are in particular parallel to each other.

Because of the particular characteristics of its armature, the motor 12, by design, “accepts” a maximum null-couple angular speed ωₘₐₓ, a minimum null-couple angular speed ωₘᵢₙ, and a maximum null-speed torque Cmₘₐₓ.

The maximum null-couple angular speed ω_{max,} and the maximum null-speed torque Cmₘₐₓ are linked by an upper rectilinear characteristic curve Cₛᵤₚ of the motor 12, represented in FIG. 3, which illustrates the possible operating points of the motor 12 for a maximum voltage power supply Uₘₐₓ, that is to say for a pulse duration Di of 100%.

The upper curve Cₛᵤₚ is parallel to the characteristic curves Cₓ.

The lower curve C_{inf} that crosses the minimum null-couple angular speed ωₘᵢₙ, represented by FIG. 3, corresponds to a minimum pulse duration Di accepted by the motor 12, thus determining a minimum null-speed torque Cmₘᵢₙ.

Conforming to the specifications of the invention, the electronic unit 14 controls the voltage pulse duration Di as a function of the value of the torque Cm applied by the motor 12, in order to obtain the operating points required, and in order to be able to better respond to the requirements of the application in process.

The measure of the torque Cm applied by the motor is performed indirectly by the measure of the intensity of the power supply current of the motor 12.

In effect, according to the equation (3), the intensity of the current I is a linear function of the torque Cm. For a given motor torque Cm, the power supply intensity I does not vary with the power supply voltage U.

However, the measures of the intensity of the current I can change because of temperature variations in the interior of the motor 12, which have an impact on the internal resistance of the motor 12, and thus on the current consumed, or again because of the accelerations of the motor 12.

In order to counterbalance these variations of the current intensity I measures, the pulse duration Di is indexed on the plateau values P_{I} of the current intensity I, and not on the gross value measured.

One thus constructs a current/pulse table T_{I/DI} that associates each current plateau value P_{I} to a pulse duration Di.

The contents of this table T_{I/DI} varies so as to adapt the performances of the motor 12 to the application for which it used.

The current/pulse table T_{I/DI} is recorded by the recording means 18 of the control device 10 of the motor 12.

Advantageously, the recording means 18 are made up programmable electronic memory of the type EEPROM (Electronically Erasable Programmable Read-Only Memory).

As a function of the application to which the electronic motor 12 is designed, one limits the null-couple angular speed ω₀ and the null-torque speed Cm₀ that the motor 12 must furnish.

One then constructs the current/pulse table T_{I/DI} in accordance with this data, so that the characteristic curve Cₓ of the angular speed ω as a function of the torque Cm globally describes a straight line linking the null-couple angular speed ω₀ and the null-torque speed Cm₀ that were chosen.

One will designate the curve Cₓ obtained from the current/pulse table T_{I/DI} as “constructed curve.”

Preferentially, for the null-speed torque Cm₀, one chooses the maximum torque Cmₘₐₓ of the motor 12, which enables always being able to benefit from the maximum torque available.

On FIG. 4, there is represented two examples C₁, C₂ of curves constructed from the values of two associated current/pulse tables T_{I/DI.} These two current/pulse tables T_{I/DI} are illustrated, respectively, by the two curves C_{T1}, C_{T2} of FIG. 5.

For the first constructed curve C₁, one has chosen a null-couple angular speed ω₁ that is equal to, for example, the majority of the maximum angular speed ωₘₐₓ of the motor 12, and one has chosen a null-torque speed that is equal to the maximum torque Cmₘₐₓ of the motor 12.

One has here determined thirteen current intensity I plateaus P_{I}, to which one has associated thirteen pulse durations Di that spread from approximately 50% to 100%.

The curve C_{T1} of FIG. 5, which illustrates the table T_{I/DI} serving to construct the curve C₁, is thus a multi-staged curve that raises with the augmentation of the intensity of the current I, that is to say, with the augmentation of the motor torque Cm.

One notices that the constructed curve C, in FIG. 4 is not continuous since it is formed from parallel portions of the characteristic curve Cₓ that corresponds respectively to each of the pulse durations Di contained in the table T_{I/DI.}

The constructed curve C, globally follows a theoretical characteristic curve that links, here in a rectilinear manner, the chosen null-couple angular speed ω₀, here ω_{1,} and the maximum null-speed torque Cmₘₐₓ.

One proceeds in a similar manner to obtain the second constructed curve C₂.

For this second constructed curve C₂, one has chosen a null-couple angular speed ω₂ that is equal to the minimum angular speed ωₘᵢₙ of the motor 12, a number of plateaus P_{I} equal to thirteen, pulse durations Di spread from approximately 35% to 100%.

It is noticeable that the smaller the null-couple angular speed ω₀, opposite from the maximum angular speed ωₘₐₓ, the higher the steps E of the pulse duration Di between two current plateaus P_{I}, and inversely, the closer the null-couple angular speed ω₀ is to the maximum angular speed ωₘₐₓ, the smaller the steps E of the pulse duration Di between two current plateaus P_{I}.

This is why, preferentially, the number of current plateaus P_{I} is variable and depends on required null-couple angular speed ω₀, so that the number of current plateaus P_{I} increases with the spread value between the chosen null-couple angular speed ω₀ and the maximum angular speed ωₘₐₓ of the motor 12.

One can define a maximum pulse duration Di step value E, for example 3%, which here leads to the number of plateaus P_{I} being able to vary from twelve to twenty-eight.

In the production examples represented in FIGS. 4 and 5, the size of the current plateaus P_{I} is substantially constant. According to a production variant (not represented), one can foresee a current/pulse table T_{I/DI} in which the size of the current plateaus P_{I} is variable.

In a similar manner, one can foresee a current/pulse table T_{I/DI} in which the size of the steps E of the pulse duration Di is variable.

According to another production variant, one can diminish the size, or length, of the plateaus P_{I} until they correspond substantially to the punctual values, which permits smoothing the corresponding constructed curve (C₁ or C₂).

The functioning of the control device 10 according to the invention process is as follows.

When starting, the electronic unit 14 drives the power supply device 16 so that it powers the motor 12 at a minimal voltage Uₘᵢₙ which corresponds to minimal voltage pulse duration Di.

The value of the intensity I of the current consumed by the motor 12 is thus minimal, that is to say that it is contained in the first current plateau P_{I1}.

While driving the wiper blade, the motor 12 encounters a resisting torque, which provokes an increase in the current intensity I.

The control device 10 continuously measures the value of the intensity I of the current, as soon as it surpasses the threshold value I_{S1} separating the first P_{I1} and the second P_{I2} current plateaus, then the electronic unit 14 determines, from the table T_{I/DI} contained in the memory 18, the pulse duration Di corresponding to the second current plateau P_{I2} and it controls the power supply device 16 so that the pulse duration Di “follows” the indications contained in the table T_{I/DI.}

In the present case, for increasing intensity I of the current, the electronic unit 14 controls the power supply 16 so that it increases the value of the pulse duration Di.

The increase of the pulse duration Di here allows diminishing the loss of speed ω of the motor 12, due to the resisting torque encountered.

Following the movement of the resisting torque met by the motor 12, the electronic motor 14 adapting the value of the pulse duration Di to the measured current value I, as a function of the indication furnished by the memory 18.

In this way, if the resisting torque encountered by the motor 12 diminishes, then the electronic unit 14 controls the diminution of the value of the pulse duration Di, which allows reduction in the increase of the angular speed ω of the motor 12, due to the sudden diminution of the resisting torque.

The process of the invention thus allows adjustment of the angular speed ω of the motor to the resisting torque, in order to avoid sudden acceleration or sudden deceleration of the wiper blade.

According to a production variant of the invention, which is illustrated in FIGS. 6 and 7, one can also control the motor 12 so that it preserves a notably stable angular speed ω over a large range of its functioning.

For that, one defines a “virtual” null-torque speed Cmᵥᵢᵣ which is considerably higher than the maximum torque Cmₘₐₓ accepted by the motor 12.

One then constructs a curve C₃ in a manner similar to curve C₁ in FIG. 4.

The curve C₃ follows a straight line D₃ linking the null-couple angular speed ω₀, here ω₃, and the virtual torque Cmᵥᵢᵣ. Since the virtual torque Cmᵥᵢᵣ is much higher that the maximum torque Cmₘₐₓ, the line D₃ reaches far towards the right in FIG. 6, such that it is slightly inclined in relation to the horizontal.

The first portion of curve C₃, situated between the null-torque speed (point A) and its intersection point J with the upper curve Cₛᵤₚ, is close to horizontal. Consequently, between point A and point J, the motor 12 operates with a substantially stable angular speed Ω, whatever the resisting torque applied to the motor 12.

When the motor torque Cm surpasses the threshold value Cm_{J} corresponding to point J, the curve C₃ can no longer follow the line D₃ because it extends beyond the capacities of the motor 12, such as those defined by design and those illustrated by the upper curve Cₛᵤₚ. The curve C₃ thus follows the upper curve Cₛᵤₚ until the maximum null-torque speed Cm.

FIG. 6 also represents a curve C₄ that is constructed in a manner similar to curve C₃, but the null-couple angular speed ω₄ of which is substantially equal to the minimum angular speed ωₘᵢₙ of the motor 12.

As for the constructed curves C₁, C₂ in FIG. 4, the curves C₃, C₄ in FIG. 6 are constructed from the table T_{I/DI} which are illustrated respectively the two curves C_{T3}, C_{T4} in FIG. 7.

One remarks that when the curve C₃ reaches the upper curve Cₛᵤₚ, here at point J, the pulse duration Di reaches its maximum value of 100%. The motor 12 then operates at its maximum capacity, which is defined by its design.

This production variant allows regulation of the speed ω of the motor 12 so that it is constant, without being necessary to add a speed sensor to the motor 12.

Thanks to the process according to the invention, one can use one type of electric motor 12 with one type of armature for different applications, without penalty in terms of the available motor torque Cm. It thus suffices to size the motor 12 and its armature as a function of the most constraining application.

Next, the adaptation of the motor 12 to each application consists principally of recording a table T_{I/DI} that is adapted to the desired application, notably in terms of the null-couple angular speed ω_{0.}

The adaptation of the motor 12 to each application is thus uniquely produced via the intermediary of the electronic control motor 12, and not by the size of the components of the motor 12.

In addition, thanks to the invention process, it is possible to benefit at all times from the maximum available torque Cm.

The use of a single type of armature allows standardization of the electromagnetic components of the motors 12, thus reducing the number of armature references. Thanks to this standardization, motor 12 manufacturing costs are diminished since there is no more than one motor 12 reference and no more than one armature reference to manage for a large number of applications.

One notes that the invention process also permits easy correction of dispersions in the performances between identical motors 12, from manufacturing chains, since it suffices to program the control device 10 in such a way as to obtain, for example, an identical null-couple angular speed ω₀ for all motors 12.

In certain applications, the motor 12 comprises an electronic communication device to go from a small angular speed PV to a big angular speed GV.

Thanks to the invention, there is no loss of torque Cm when the speed ω of the motor 12 is controlled, in particular when the wiper blade is near one end of its course.

The invention permits, in particular, an increase of the ease of the wiper blade on a ramp corresponding to the parked position, since one can control the angular speed ω of the motor 12, all while preserving a maximum motor torque Cm.

In addition, the process of the invention permits braking the motor 12 when the control device measures a negative current, that is to say which the motor 12 generates, for example, following a gust of wind.

In a development of the process according to the invention, the electronic unit 14 can also control the pulse duration Di as a function of the position of the wiper blade on the glass surface.

The electronic unit 14 can determine the position of the wiper blade by means of a sensor 20 which is represented in FIG. 2. This sensor measures, for example, the angular position of the exit shaft of the motor 12.

In the frame of this development, the operating points of the motor 12 are determined by means of reducing the kinetic energy stored by the wiper blade, or wiper arm, when it arrives near an end of the wiped surface, that is to say, near the fixed stop point (AF) and the point opposite the fixed stop point (OAF).

The operating points thus define a profile of angular speed ω as a function, for example, of the angular position of the exit shaft of the motor 12.

According to a variance of the process according to the invention, the electronic unit 14 can control the power supply device 16 so that the motor 12 operates following the operating points that globally follow a theoretical non-linear characteristic curve C_{y} between an null-couple angular speed ω₀ and a chosen maximum null-torque speed Cm₀.

Such a non-linear curve Cy is represented in FIG. 2 by a dotted line.

The invention thus permits exploiting the maximum mechanical capacities of the motor 12 by precisely defining each of the operating points.

According to another variance (not represented) of the process according to the invention, the electronic unit 14 calculates, at regularly-spaced intervals, the pulse duration Di applied to the motor 12 by means of a transfer function.

The transfer function can vary as a function of the required operating points of the motor.

This variance allows direct adaptation of the value of the pulse duration Di to the value of the measured current intensity I, without resorting to the current plateaus P_{I}.

For this variance, the recording means 18 are not essential since the transfer functions can be directly programmed in the electronic control unit 14, for example by means of an equation.

Note that the process according to the invention can be put into place by means of a digital and/or analog electronic unit 14.

1. Method for electronic regulating of an electronic motor (12), in particular a wiper mechanism motor (12) in order to drive at least a wiper blade or arm, moving on a glass surface, of the type in which a control device (10) supplies the motor (12) with voltage (U) by specific pulse durations (Di), each pulse duration (Di) determining a substantially rectilinear characteristic curve (Cₓ) of operating points corresponding to doublets of values, respectively of the torque (Cm) and the angular speed (ω) of the motor (12), between two threshold points (A, B) corresponding to a null-couple angular speed (ω₀) and a null-speed torque (Cm₀), characterized in that one controls the voltage (U) pulse duration (Di) as a function of the measured value of the intensity (I) of the current powering the motor (12), in order to obtain each doublet of values, or operating point, required.

2. Process according to the preceding claim, characterized by the pulse duration (Di) being indexed on the plateau values (P_{I}) of the intensity (I) of the current.

3. Process according to the preceding claim, characterized by increasing the number of values the current plateau (P_{I}) when one increases the value of the spread between the maximum null-couple angular speed (ωₘₐₓ) of the motor (12), defined by design, and the required null-couple angular speed (ω₀).

4. Process according to either of claims 2 or 3, characterized by diminishing the number of plateaus (P_{I}) until they substantially correspond to the point values, in order to smooth the characteristic curve (C₁, C₂) from the corresponding values of pulse duration (Di) and intensity (I).

5. Process according to any of the preceding claims, characterized by controlling the pulse duration (Di) by globally following a theoretic characteristic curve linking the required null-couple angular speed (ω₀) to the required null-speed torque (Cm₀).

6. Process according to the preceding claim, characterized by the theoretic characteristic curve being a line that links the required null-couple angular speed (ω₀) to the required null-speed torque (Cm₀).

7. Process according to claim 5, characterized by controlling the pulse duration (Di) in order to globally follow, within the limits of the physical capacity of the motor (12) defined during design, a line (D₃, D₄) that links the null-couple angular speed (ω₀) to a virtual null-speed motor torque (Cmᵥᵢᵣ), the virtual null-speed motor torque (Cmᵥᵢᵣ) being greater than the maximum null-speed torque (Cmₘₐₓ), so that the angular speed (ω) is appreciably as stable as the motor torque (Cm) is lower than a threshold value (Cm_{J}) defined by the design.

8. Process according to any of the preceding claims, characterized by the required null-speed torque (Cm₀) is the maximum null-speed torque (Cmₘₐₓ) of the motor (12) which is defined by the design.

9. Process according to any of the preceding claims, characterized by the pulse duration (Di) values as a function of the values of the intensity (I) of the current being recorded in a table (TV), the contents of which vary as a function of the required operating points of the motor (12), and by controlling the pulse duration (Di) by following the indications on the table (T_{I/DI).}

10. Process according to any of claims 1 to 8, characterized by, at regular intervals, the control device (10) calculating the pulse duration (Di) to be applied to the motor (12), by means of a transfer function, the transfer function varying as a function of the operating points required by the motor (12).

11. Process according to any of the preceding claims, characterized by the required operating points being determined in order to reduce the kinetic energy stored by the wiper blade, when it arrives near an end of the wiped surface.

12. Process according to any of the preceding claims, characterized by being started by a control device (10) comprising a digital and/or analog electronic control unit (14).
